(19) United States
(12) Patent Application Publication
(10) Pub. No.: US 2009/0223597 A1
(43) Pub. Date: Sep. 10, 2009

(54) Fuel fill cuff fuel nozzle attachment with floatation capability

(76) Inventor: Alan Castro, Beverly Hills, CA (US)

Correspondence Address: Alan Castro, 269 S. Beverly Dr., #423, Beverly Hills, CA, 90212, US

(21) Appl. No.: 12/074,530

(22) Filed: Mar. 4, 2008

(51) Int. Cl. B67D 5/06; B67D 5/04

(52) U.S. Cl. 141/392; 141/1

(57) ABSTRACT

A device that is placed over an inlet of a fuel tank for an automobile, motorcycles, watercraft or other vehicle, that prevents the overflow of fuel during the filling of the fuel tank. The device allows the user to completely fill the gasoline or fuel tank on the vehicles without getting their hands soiled. The device comprises an upper portion that accepts a fuel pump nozzle, an inner core that captures fuel fumes and provides for pressure build up inside the fuel tank, and a lower portion that is designed to engage the fuel tank opening. The upper portion and inner core are generally the same on each embodiment. The lower portion of the different embodiments, however, are specifically designed to adapt to different types of fuel tank openings, including flush mounted and indented gas tank inlets. The present Fuel Fill Cuff Fuel Nozzle Attachment Device with Floatation Capability gives the operator of motorcycles, watercraft and other gasoline or fuel powered machines, the same advantages of filling their tanks to a desired full level, as those enjoyed by car operators, by working in conjunction with the automatic shut-off feature available in most fuel pumps.

### BACKGROUND OF THE INVENTION

The present invention relates generally to the field of fuel filling accessories, and more specifically to an apparatus that allows non-traditional vehicles, such as watercraft, to fill their fuel tanks without overflow.

Watercraft have many uses in business, industry, tourism and for recreation. Watercraft, are used for economical transportation, racing and for fun. Watercraft, such as small boats and personal watercraft, can even be found in the military. Since most watercraft have internal combustion engines, they also have a gasoline tank that must periodically be refilled. Gasoline is a mixture of the lighter liquid hydrocarbons used chiefly as a fuel for internal-combustion engines. It is produced by the fractional distillation of petroleum; by condensation or adsorption from natural gas; by thermal or catalytic decomposition of petroleum or its fractions; by the hydrogenation of producer gas or coal; or by the polymerization of hydrocarbons of lower molecular weight. Gasoline has many unfavorable characteristics that necessitates care when handling the flammable liquid. Thus, when refilling a motorcycle gas tank it is important not to let the gas tank overflow. Gasoline will be absorbed by clothing and other cloth like material, rendering the material flammable. For the careless driver that forgets about gas soaked clothing this could spell disaster at a later time, such as when the person is standing around a campfire or lighting a cigarette. Gasoline also has caustic characteristics. If it is splashed on the outside of a motorcycle's gas tank it will eventually cause fading of the paint and finish of the gas tank. Gasoline also has a caustic effect on skin. An overflow during filling could cause gas to be splashed on the hands or other parts of the person doing the filling. If the affected area of skin is not washed immediately the person will experience a burning sensation. Further, unwashed hands and fingers with gasoline residue on them could cause burning and irritation of the eyes if the person later uses his fingers to rub his eyes or eyelids. Finally, not to be forgotten is the unpleasant odor of gasoline. Spilling and overflow of gasoline on any item will leave the item with a smell of gasoline that is harmful to the person and the environment.

In an attempt to capture and otherwise limit the fumes and smell that are emitted during the filling of gas tanks, gas pump manufacturers have instituted the use of a corrugated rubber nozzle that surrounds the gasoline dispensing nozzle. This rubber nozzle is intended to fit around the outside of a gas tank inlet while the metal nozzle is inserted down and into the gas tank inlet. During filling of the tank, any fumes that try to escape from the gas tank are prevented by a seal the rubber nozzle forms around the outside of the gas tank inlet. Many gas pumps will not even allow the flow of gasoline to begin until the rubber hose is pushed back a sufficient distance from the tip of the metal nozzle. Almost all gas pump systems also have an auto shut-off feature whereby the gas pump detects when the gas tank is full based on pressure that is felt by the gas coming out of the gasoline dispensing nozzle. Such an automatic shut-off feature works well with automobile gas tanks where the gasoline must travel some distance down a fill tube before it ultimately reaches the gas tank. The fill tube acts as a safety overflow device allowing the gas pump time to realize the gas tank is full and automatically stop before an overflow occurs. Watercraft generally do not have a tube leading to the gas tank. Rather, the gasoline dispensing nozzle is inserted directly into the gas tank itself. Therefore, no extra time is provided between the filling of the gas tank and the initiation of the automatic shut-off feature, leading to unwanted overflows. One can understand how this happens by imagining a situation where a person filling a car's gas tank wishes to “top off” the gas tank; fill the car's tank so that the gasoline level can be seen at the tank inlet. In such a situation, the person doing the filling lets the automatic shut-off feature stop the filling of the gas tank at its regular time. However, since the person wishes to fill not only the gas tank but the fill tube also, he starts filling the tank again. When the auto shut-off feature stopped the gas flow the first time, there was no overflow. However, on the second occurrence of the auto shut-off feature, gasoline overflows from the gas tank. This is because the fill tube was already partially filled during the first filling and during the second subsequent filling there is not enough empty space in the fill tube to hold all of the gasoline that continues to be dispensed even though the auto shut-off feature has been initiated. Such is the situation with motorcycle gas tanks. Many times motorcycle drivers will hold the rubber nozzle up and out of the way so that they can see the level of gas in the gas tank as it start to rise. This method allows the rider to stop filling before an overflow occurs, however, it also requires the motorcycle rider to soil his fingers with soot and gas residue from the rubber hose.

It is therefore an object of the present invention to prevent unwanted overflows when filling gas tanks of vehicles such as boats and personal watercraft. It is also an object to provide a device that allows drivers of these vehicles to fill their gas tanks without getting their fingers dirty from the rubber fume catching tubes and gasoline residue. It is further an object to let watercraft riders take advantage of the auto shut-off feature of gasoline pumps, wherein the auto shut-off feature stops the flow of gasoline before any overflow of gasoline occurs.

### SUMMARY OF THE INVENTION

The purpose of the present invention is to provide a new Fuel Fill Cuff Fuel Nozzle Attachment Device that has many novel features not offered by the prior art apparatus that result in a new Fuel Fill Cuff Fuel Nozzle Attachment Device with Floatation Capability which is not apparent, obvious, or suggested, either directly or indirectly by any of the prior art apparatus

The present invention generally comprises a principally cylindrical upper portion, a generally cylindrical, substantially hollow inner core that runs the length of the device and a generally cylindrical lower portion that temporarily removeably attaches to the gas tank opening. The generally cylindrical, substantially hollow inner core can have flexible membranes that permanently attach to the inner wall surface of the core to prevent gas fumes from escaping out of the gas tank and into the atmosphere. The lower portion is specifically designed to meet the connective device interface requirements for each different type of fuel containment tank opening, including but not limited to, flush mounted or indented gas tank inlets, on each different type of fuel operated vehicle. The present invention can be made of a variety of different materials including but not limited to, hydrocarbon polymers (or rubber), polypropylene plastic, polyurethane foam, styrofoam, composite foams, composite plastics, pvc, wood, cardboard, paper, steel, aluminum, platinum, cast iron, and any general use plastic, or metal alloy not referred to herein.

The present invention provides a device that is used to prevent the overflow of liquid, such as, but not limited to, fuel for various types of gasoline consuming vehicles during the transference of such liquid from a holding container to the gas or fuel tank of the gasoline consuming vehicle. The present invention also allows the user to fill the gas or fuel tank of the gasoline consuming vehicle without getting his hands soiled.

Accordingly several advantages and objects of the present invention are:

A principal object of the present invention is to provide a Fuel Fill Cuff Fuel Nozzle Attachment Device with Floatation Capability that will overcome the deficiencies of the prior art devices.

An object of the present invention is to provide a Fuel Fill Cuff Fuel Nozzle Attachment Device with Floatation Capability that prevents the overflow of fuel when filling a gasoline or fuel tank.

Another object of the present invention is to provide a Fuel Fill Cuff Fuel Nozzle Attachment Device with Floatation Capability that allows the user to completely fill the gasoline or fuel tank without the user's hands getting soiled.

Another object of the present invention is to provide a Fuel Fill Cuff Fuel Nozzle Attachment Device with Floatation Capability that is adaptable to any type of fuel tank opening for any type of gasoline or fuel consuming vehicle.

Another object of the present invention is to provide a Fuel Fill Cuff Fuel Nozzle Attachment Device with Floatation Capability wherein, the lower portion is adapted to fit flush mounted fuel tank openings.

Another object of the present invention is to provide a Fuel Fill Cuff Fuel Nozzle Attachment Device with Floatation Capability wherein, the lower portion is adapted to fit recessed fuel tank openings.

Another object of the present invention is to provide a Fuel Fill Cuff Fuel Nozzle Attachment Device with Floatation Capability wherein, the inner core has a general funnel shape and an area between an outer wall of the apparatus and the inner core is solid.

Another object of the present invention is to provide a Fuel Fill Cuff Fuel Nozzle Attachment Device with Floatation Capability.

Another object of the present invention is to provide a Fuel Fill Cuff Fuel Nozzle Attachment Device with Floatation Capability is to provide a method for preventing an automatic shut-off feature of a standard fuel pump from activating prematurely.

Another object of the present invention is to provide a Fuel Fill Cuff Fuel Nozzle Attachment Device with Floatation Capability that is more universally functional in today's market than the prior art devices.

### BRIEF DESCRIPTION OF THE DRAWINGS

The invention of the present application will now be described in more detail with reference to the accompanying drawings, given only by way of example, in which:

FIG. 1. is a perspective view of a Fuel Fill Cuff Fuel Nozzle Attachment Device with Floatation Capability according to the present invention.

FIG. 2. is a perspective bottom view of a Fuel Fill Cuff Fuel Nozzle Attachment Device with Floatation Capability according to the present invention.

FIG. 3. is a perspective view of an alternate embodiment of a Fuel Fill Cuff Fuel Nozzle Attachment Device with Floatation Capability according to the present invention.

FIG. 4. is a perspective bottom view of an alternate embodiment of a Fuel Fill Cuff Fuel Nozzle Attachment Device with Floatation Capability according to the present invention.

FIG. 5. is a perspective view of another alternate embodiment of a Fuel Fill Cuff Fuel Nozzle Attachment Device with Floatation Capability according to the present invention.

FIG. 6. is a perspective bottom view of another alternate embodiment of a Fuel Fill Cuff Fuel Nozzle Attachment Device with Floatation Capability according to the present invention.

FIG. 7. is a perspective view of still another alternate embodiment of a Fuel Fill Cuff Fuel Nozzle Attachment Device with Floatation Capability according to the present invention.

FIG. 8. is a perspective bottom view of still another alternate embodiment of a Fuel Fill Cuff Fuel Nozzle Attachment Device with Floatation Capability according to the present invention.

FIG. 9. is a perspective view of yet a different embodiment of a Fuel Fill Cuff Fuel Nozzle Attachment Device with Floatation Capability according to the present invention.

FIG. 10. is a perspective bottom view of yet a different embodiment of a Fuel Fill Cuff Fuel Nozzle Attachment Device with Floatation Capability according to the present invention.

FIG. 11. is a top view of a Fuel Fill Cuff Fuel Nozzle Attachment Device with Floatation Capability according to the present invention.

FIG. 12. is a bottom view of a Fuel Fill Cuff Fuel Nozzle Attachment Device with Floatation Capability according to the present invention.

FIG. 13. is a cross sectional view of the present invention seen in FIG. 11, taken along line A-A of that drawing of a Fuel Fill Cuff Fuel Nozzle Attachment Device with Floatation Capability according to the present invention.

FIG. 14. is a cross sectional view of the present invention seen in FIG. 9, taken along line B-B of that drawing of a Fuel Fill Cuff Fuel Nozzle Attachment Device with Floatation Capability according to the present invention.

FIGS. 15 and 16 illustrate an alternative embodiment of the present invention that is designed to be used with fuel pumps that do not have a corrugated rubber hose.

FIG. 17 is a detailed view of inner core with a membrane that extends across the interior of core and is substantially cut in half by a slit.

FIG. 18 shows a Fuel Fill Cuff Fuel Nozzle Attachment with Floatation Capability that is designed to be used on vehicles that have an indented fuel tank opening.

FIG. 19(a) shows a collapse-able embodiment of the present Fuel Nozzle Attachment in the extended position.

FIG. 19(b) shows the collapse-able embodiment of the present Fuel Nozzle Attachment in the closed, or collapsed, position.

### DETAILED DESCRIPTION OF THE INVENTION

Referring now descriptively to the drawings, the attached figures illustrate a Fuel Fill Cuff Fuel Nozzle Attachment Device with Floatation Capability according to the present invention,

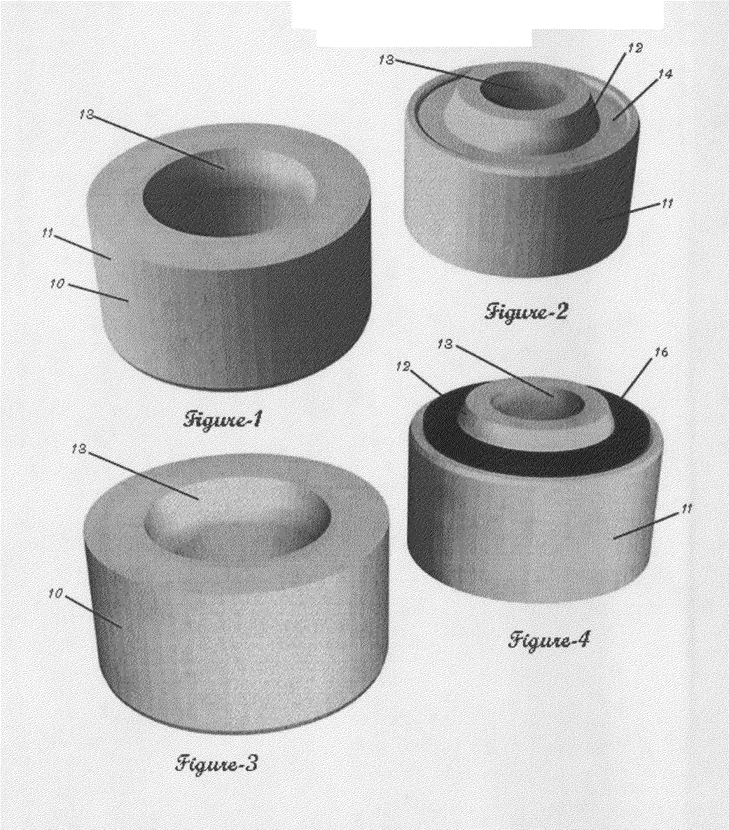

FIGS. 1 and 2 illustrate a device 10 that is placed over an inlet of a fuel tank for such apparatus including but not limited to Automobiles, Trucks, Motorcycles, Watercraft, Airplanes, Helicopters, Industrial Equipment, Farm Vehicles, Military Vehicles, and any other Gasoline or Fuel Powered Machine not mention herein, that prevents the overflow of fuel during the filling of the fuel tank on the afore mentioned gasoline or fuel consuming vehicles as well as allows the user to completely fill the gasoline or fuel tank on said vehicles without getting hands soiled. The device 10, referred to herein as the “Fuel Fill Cuff Fuel Nozzle Attachment Device with Floatation Capability” comprises an upper portion 11 that accepts a fuel pump nozzle, an inner core 13 that captures fuel fumes and provides for pressure build up inside the fuel tank, and a lower portion 12 that is designed to mesh with the fuel tank opening for such apparatus including but not limited to Automobiles, Trucks, Motorcycles, Watercraft, Airplanes, Helicopters, Industrial Equipment, Farm Vehicles, Military Vehicles, and any other Fuel Powered Machine not mention herein. The upper portion 11 and inner core 13 are basically the same on each model of the Fuel Fill Cuff Fuel Nozzle Attachment Device with Floatation Capability. The lower portion 12 of the Fuel Fill Cuff Fuel Nozzle Attachment Device with Floatation Capability is specifically designed to adapt to different types of fuel tank openings including but not limited to, flush mounted or indented gas tank inlets, on each different type of fuel operated vehicle. The Fuel Fill Cuff Fuel Nozzle Attachment Device with Floatation Capability gives the operator of Automobiles, Trucks, Motorcycles, Watercraft, Airplanes, Helicopters, Industrial Equipment, Farm Vehicles, Military Vehicles, and any other Gasoline or Fuel Powered Machine not mention herein, the same fuel filling advantages of filling their tanks to a desired full level, as those enjoyed by car operators, by working in conjunction with the automatic shut-off feature available in most fuel pumps.

FIGS. 3 and 4 illustrate an alternate embodiment of a device 10 having a flexibly rigid barrier gasket 16 placed around the beveled surface 12 and flat against the underside surface 14 of upper portion 11, with said gasket 16 acting as a barrier seal when the device 10 is placed into position against the opening of a fuel or gasoline tank, thus preventing the leaking of fuel liquid or fumes at the connection point thus allowing pressure to build up inside the fuel tank.

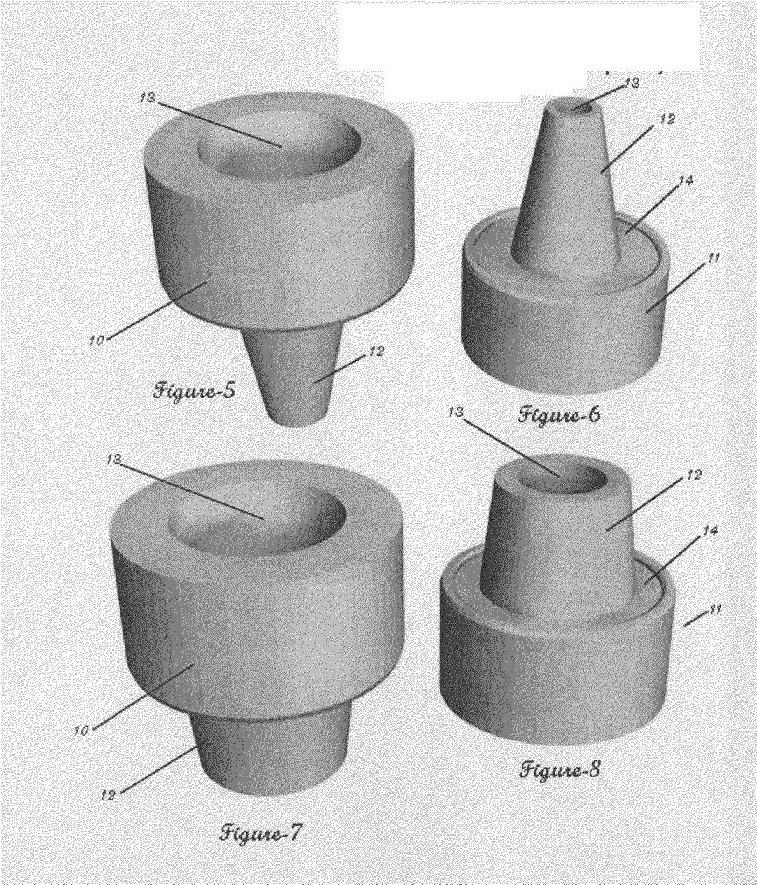

FIGS. 5 and 6 illustrate an alternate embodiment of a device 10 having an extended or elongated lower portion 12 as well as a more narrow diameter of the inner core 13 where it terminates at the lower portion 12. This optional embodiment serves to extend the lower portion 12 and inner core surface 13 down into the fuel tank of various types of vehicles for a more secure interface between the device 10 and the tank opening.

FIGS. 7 and 8 illustrate an alternate embodiment of a device 10 having an extended or elongated lower portion 12. This optional embodiment serves to extend the lower portion 12 and inner core surface 13 down into the fuel tank of various types of vehicles for a more secure interface between the device 10 and the tank opening.

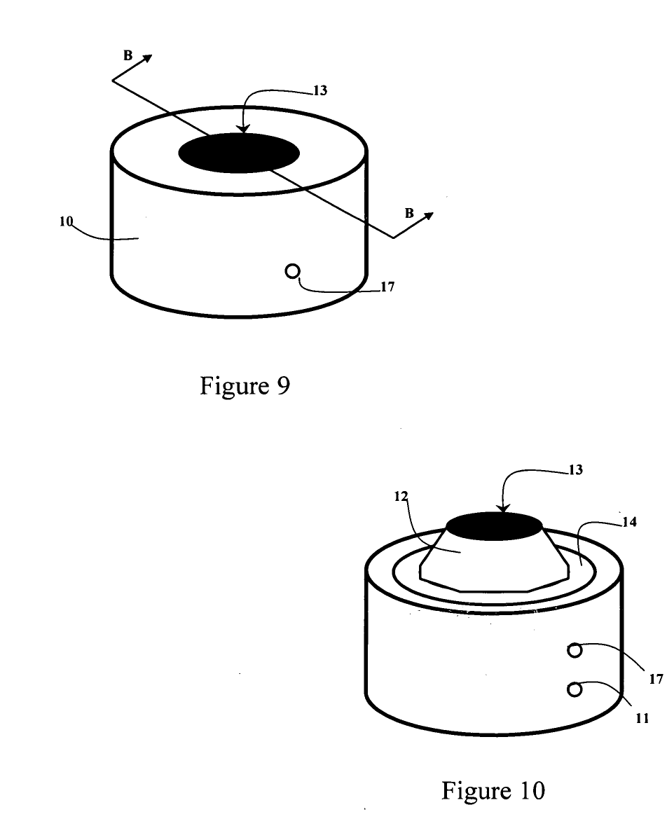

FIGS. 9 and 10 illustrate an alternate embodiment of a device 10 having a generally cylindrical hole running substantially perpendicular to the center line of inner core 13, and creating a generally cylindrical opening through the upper portion 11. This optional embodiment serves to allow for fuel fumes to vent, thus preventing the build up of fumes when the condition of elevated pressure within inner core 13 is not desired.

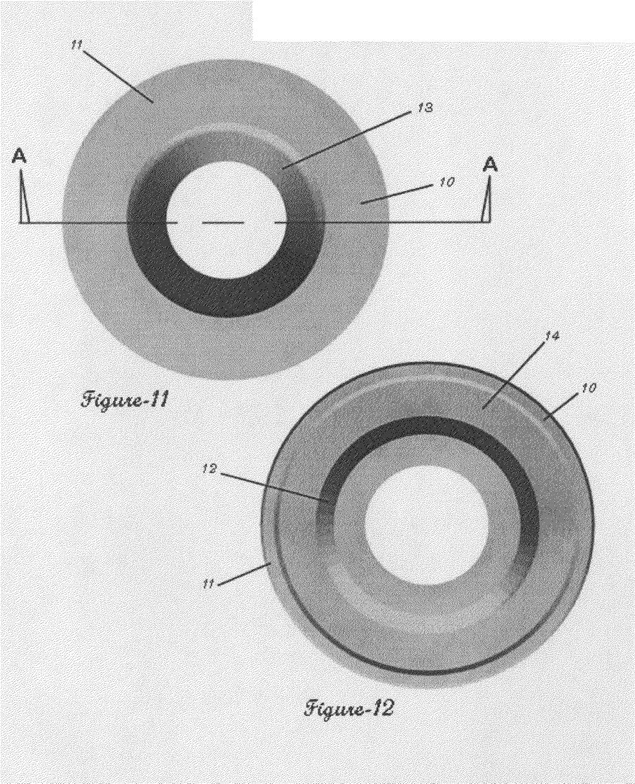

FIGS. 11 and 12 illustrate a top and bottom view respectively of the preferred embodiment of the Fuel Fill Cuff Fuel Nozzle Attachment with Floatation Capability. Outer surfaces 11, 12 and 14, define the basic shape of the cuff and inner core surface 13 defines the cone shaped nozzle receiving region. Lower portions 12, and 14 are preferably made of materials including but not limited to, a semi-hard rubber with floatation capabilities that maintains its shape but allows some flexibility. The inner circumference 13 of lower portion 12 is slightly smaller than the outer circumference of a standard Automobile, Truck, Motorcycle, Watercraft, Airplane, Helicopter, Farm Equipment, Fuel Powered Machine fuel tank inlet, so that a snug frictional attachment occurs when the cuff is pushed or twisted onto the fuel tank inlet. In operation, the fuel pump's metal or other composition nozzle is inserted through inner core 13 so that it protrudes approximately ½ inch into the fuel tank.

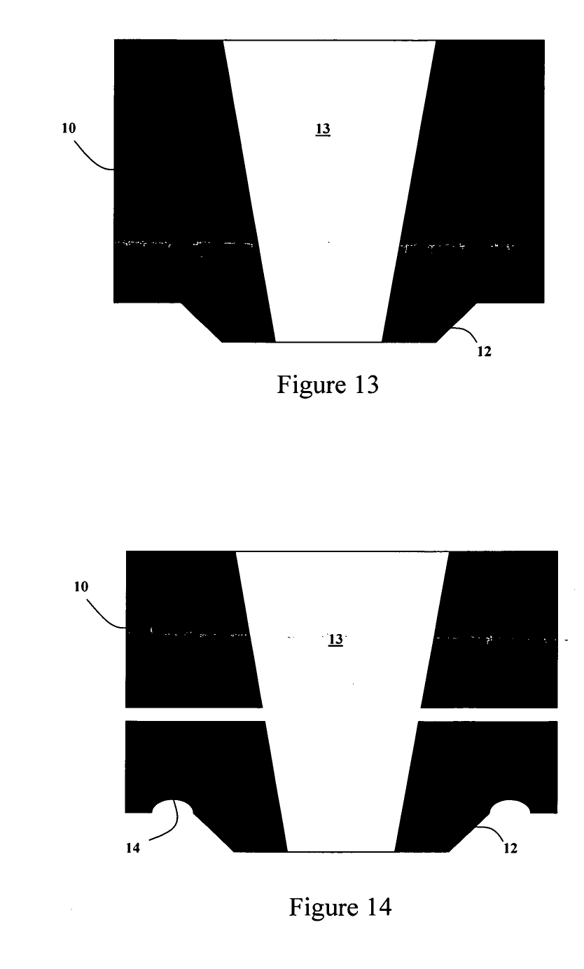

FIG. 13 is a section through the preferred embodiment of the device 10 having a tapered, generally cone shaped inner core 13 that is narrower at the lower portion 12 and wider at the upper portion 11, with the surface of the lower portion 12 having a generally tapered shape that is narrower at the bottom and wider where lower portion 12 meets upper portion 11.

FIG. 14 is a section through an alternate embodiment of the present invention 10 whereby a vent shaft 17 runs perpendicular to the centerline of inner core 13 as well as the outer wall of upper portion 11, with vent shaft 17 allowing for fumes to escape when a build up of pressure within inner core 13 is not desirable.

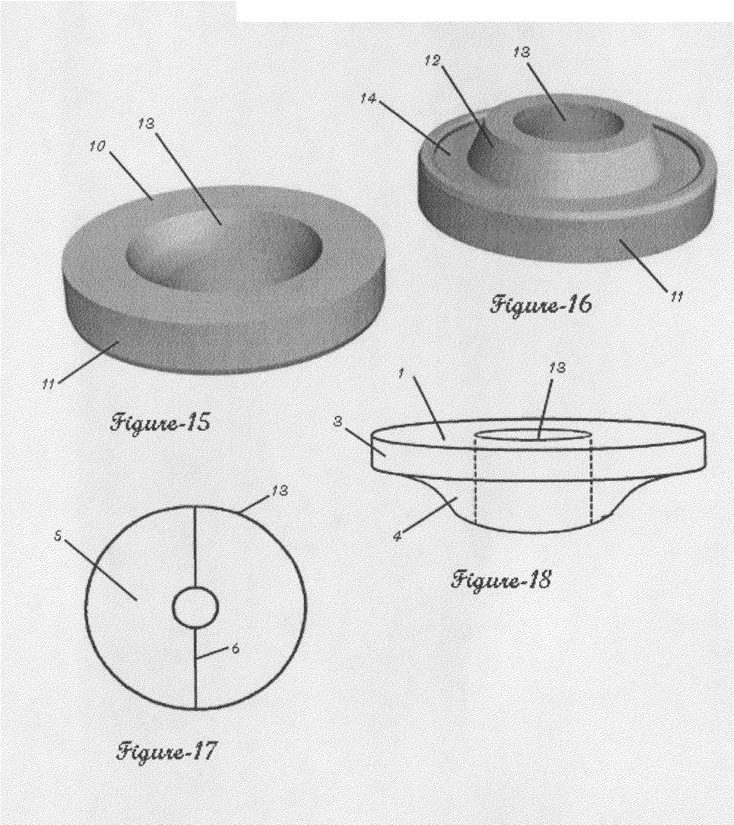

FIGS. 15 and 16 illustrate an alternative embodiment of the present invention 10. The embodiment of FIG. 15 and 16 is designed to be used with fuel pumps that do not have a corrugated rubber hose that surrounds the metal or other composition nozzle. This embodiment still has upper portion 11, inner core 13, outer wall and lower portion 12. In this embodiment, the main difference is the overall height of the device. Outer wall 11 is now substantially shorter than in the embodiment of FIG. 1. It logically follows that inner core 13 is also shorter. The device can be made shorter for fuel pumps that do not have a rubber hose surrounding the metal or other composition nozzle because there is no longer a need to “push” the rubber hose back a specified distance before the flow of fuel can begin. The fuel pump that this embodiment is used with has no rubber hose. So the user need only insert the metal or other composition nozzle through inner core 13 so that it protrudes approximately ½ inch past the device and into the fuel tank, and then squeeze the fuel pump handle to initiate the flow of fuel. Thin flaps, or membranes, in core 13 prevent fuel from splashing back up through the device and also provide sufficient pressure build up to trigger the auto shut-off feature of the fuel pump when the tank is full.

FIG. 17 is a detailed view of inner core 13. Membrane 5 extends across the interior of core 13 and is substantially cut in half by slit 6. A circular opening can optionally be left in the middle of membrane 5, so as to conform to the metal or other composition nozzle that is inserted there through. Preferably, more than one membrane is used in core 13 with each membrane being spaced some distance apart. Also, it is preferred that the slits of different membranes run perpendicular to one another so as to optimally prevent fuel from splashing out of the fuel tank and allow the required build up of pressure in the fuel tank that will trigger the automatic shut-off of fuel flow when the fuel tank is full. In an alternative embodiment, two slits are made across the length of membrane 5 so that the membrane is divided into four equal parts. In both embodiments, membrane 5 can have a hole left in its center, or no hole can be left in the center. In a further embodiment, the membrane(s) that extend across the interior of inner core 13 can be manufactured so that the “halves” or “quarters” slightly overlap each other. Of course other membranes or flaps can be designed and used with the present invention with the only limitation being that they prevent splashing of fuel back up through the inner core and that the required pressure to trigger the automatic shut-off of the pump be allowed to build up. For embodiments that do not include flexible membranes, the inner core is sufficiently small so as to form a loose seal with the metal or other composition nozzle.

FIGS. 18 shows a Fuel Fill Cuff Fuel Nozzle Attachment with Floatation Capability that is designed to be used on Automobile, Truck, Motorcycle, Watercraft, Airplane, Helicopter, Farm Equipment, Fuel Powered Machines that have an indented fuel tank opening. The device is designed to fill the space of the indentation that surrounds the fuel tank inlet and is designed to be used with fuel pumps that do not have a rubber hose around the metal or other composition nozzle. The cuff can be made shorter because with the pump that it is designed for there is no rubber hose to push back. The metal or other composition nozzle is simply inserted through inner core 13, and subsequently the membrane(s) that are housed therein, until the nozzle extends approximately ½ inch into the fuel tank. Then filling can begin in the standard manner. The above embodiments are preferably made of synthetic rubber foam that allows the Attachment to float, which is especially beneficial when being to used to fill boats and other water craft. The above Fuel Nozzle Attachments are preferably produced using the well known injection molding method. Other embodiments can be make of other materials including a sponge material that would not only float, but also be easy to clean. Other materials that can be used to produce embodiments of the present invention include hydrocarbon polymers (or rubber), polypropylene plastic, polyurethane foam, styrofoam, composite foams, composite plastics, pvc, wood, cardboard, paper, steel, aluminum, platinum, cast iron, and any general use plastic or metal alloy.

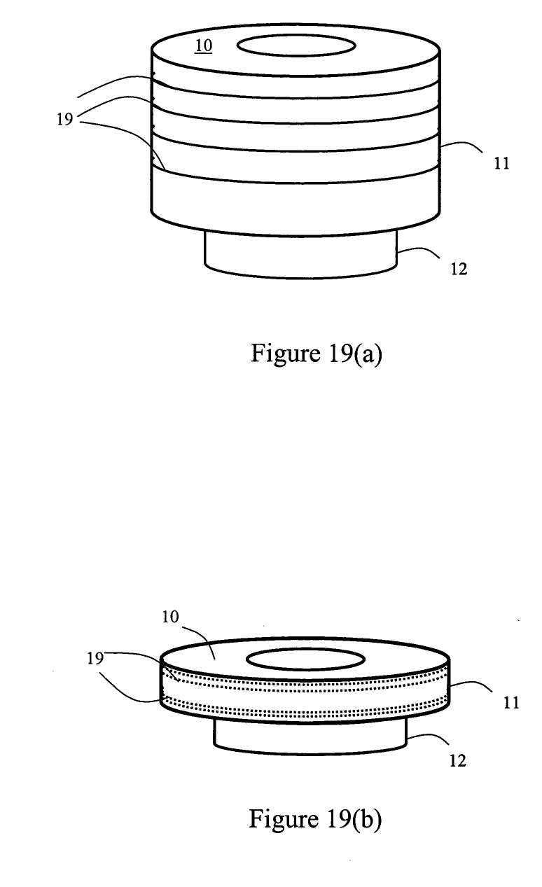

FIG. 19(a) shows a collapse-able embodiment of the present Fuel Nozzle Attachment in the extended position. The side 11 of this embodiment includes multiple small rings that are able to interlock with each other and form seams 19 when in the extended position. After being extended, the Nozzle Attachment is used in the same manner as the other embodiments, with the fuel nozzle passing through the top 10 of the Attachment and protruding through the bottom 12 of the Attachment. This collapse-able embodiment can be made of any semi-rigid material including plastic and metal.

FIG. 19(b) shows the collapse-able embodiment of the present Fuel Nozzle Attachment in the closed, or collapsed, position. After being used to precisely fill a gas tank without overflow, the operator removes the fuel nozzle, grabs the top 10 of the Attachment, taps the bottom 12 on the ground and the multiple seams 19, which were held in place by friction, disengage and the multiple rings collapse into the bottom ring. The result is a compact Fuel Nozzle Attachment that can be stored almost anywhere.

It is further intended that any other embodiments of the present invention that result from any changes in application or method of use or operation, method of manufacture, shape, size, or material which are not specified within the detailed written description or illustrations contained herein yet are considered apparent or obvious to one skilled in the art are within the scope of the present invention.

The foregoing description of the specific embodiments will so fully reveal the general nature of the invention that others can, by applying current knowledge, readily modify and/or adapt for various applications such specific embodiments without departing from the generic concept. Therefore, such adaptations and modifications should and are intended to be comprehended within the meaning and range of equivalents of the disclosed embodiments. It is to be understood that the phraseology of terminology employed herein is for the purpose of description and not of limitation.

I claim:

1. A fuel nozzle cuff that is adapted to fit around a nozzle that dispenses fuel, wherein the cuff allows a fuel tank to be filled without an overflow and spillage occurring, the fuel nozzle cuff comprising:
a cylindrical body, the cylindrical body having an opening at a top of the body, an opening at a bottom of the body and a passageway through an interior of the cylindrical body, wherein the opening at the bottom of the body is adapted to frictionally engage with the nozzle that dispenses fuel and the bottom of the body is adapted to cover an opening to the fuel tank, and further wherein the nozzle cuff provides a build up of pressure inside the fuel tank so that an automatic shut-off feature of a fuel pump is initiated before fuel overflows out of the fuel tank, wherein the cylindrical body is made of a material that is able to float in water.

2. The fuel nozzle cuff of claim 1, wherein the opening at the top of the body is at least twice as wide as the opening at the bottom of the body, and wherein the wider opening at the top of the body allows the fuel nozzle to rest at various angles relative to the cylindrical body.

3. The fuel nozzle cuff of claim 1, wherein the opening at the bottom of the body includes an extension that extends the opening at the bottom a distance past a bottom surface of the body, and further wherein the extension has a conical shape.

4. The fuel nozzle cuff of claim 1, wherein a bottom surface of the cylindrical body includes a liner, wherein the liner is adapted to make contact with the opening in the fuel tank.

5. The fuel nozzle cuff of claim 1, wherein the cylindrical body has a height of 1-5 inches.

6. The fuel nozzle cuff of claim 1, wherein the passageway through the interior of the body has a shape of a cone with the opening at the top of the body being wide and the cone shaped passageway tapering down to the opening at the bottom of the body.

7. The fuel nozzle cuff of claim 1, wherein cylindrical body is made of a multiple, interlocking rings that allow the body to achieve an extended position, wherein the cuff may be used for filling the fuel tank, and a collapsed position, wherein the cuff may be stored in a small compartment.

8. The fuel nozzle cuff of claim 1, wherein the cylindrical body is made of a foam rubber material that allows the cuff to float in water.

9. The fuel nozzle cuff of claim 1, wherein the cylindrical body is made of a sponge material that allows the cuff to float in water.

10. The fuel nozzle cuff of claim 1, wherein the passageway through the interior of the body includes a flexible membrane that allows for passage there-through of the nozzle, but prevents fumes from escaping from the fuel tank during fueling.

11. A method for filling a fuel tank and preventing overflow involving the use of a fuel nozzle cuff, the cuff having a cylindrical body, the cylindrical body having an opening at a top of the body, an opening at a bottom of the body and a passageway through an interior of the cylindrical body, wherein the opening at the bottom of the body is adapted to frictionally engage with a fuel dispensing nozzle and the bottom of the body is adapted to cover an opening to the fuel tank, wherein the cylindrical body is made of a material that is able to float in water, the method comprising the steps of:
inserting a tip of the nozzle through the opening in the top of the cylindrical body so that the tip of the nozzle travels through the interior of the body and protrudes outside the bottom of the body;
placing the tip of the nozzle into the fuel tank so that the bottom of the fuel nozzle cuff engages with the opening to the fuel tank;
filling the gas tank with fuel, wherein the cuff prevents fuel from splashing out of the fuel tank, contains fumes within the tank and provides for pressure build up inside the fuel tank, which allows an automatic shut-off feature of a fuel pump to be initiated before fuel overflow the fuel tank.

12. The method of claim 11, wherein the fuel nozzle cuff is made of a semi-flexible rubber foam material.

13. The method of claim 11, wherein the nozzle cuff has a height of one to five inches.

14. The method of claim 11, wherein the passageway in the interior includes a flexible membrane that assists in containing fumes and building pressure within the tank.

15. The method of claim 11, wherein the nozzle cuff is made of a sponge material.

16. The method of claim 11, wherein the cuff includes a collapse-able cylindrical body, and the cuff is able to move between an extended position, wherein the cuff can be used for filling the tank, and a collapsed position, wherein the cuff achieves a smaller size for storage.

17. The method of claim 11, wherein the interior passageway tapers in size from the top to the bottom of the cylindrical body.

18. The method of claim 11, wherein the opening at the bottom of the body protrudes past a bottom surface of the body and the protrusion has the shape of a cone.

19. The method of claim 11, wherein the bottom of the cylindrical body includes a liner that is adapted to engage the opening to the fuel tank.

20. The method of claim 11, wherein the opening at the top of the body is at least twice as wide as the opening at the bottom, and the wide opening at the top allows the nozzle to rest at various angles while fueling.
